(19) United States
(12) Patent Application Publication
(10) Pub. No.: US 2003/0004809 A1
(43) Pub. Date: Jan. 2, 2003

(54) Method and system for automatically calculating and managing consumer earned equity

(75) Inventors: Patric M. Palcic, Highland, NY (US); Paul D. Hakim, Hurley, NY (US)

Correspondence Address: PENNIE AND EDMONDS, 1155 AVENUE OF THE AMERICAS, NEW YORK, NY, 100362711

(73) Assignee: Raymond S. Koloski

(21) Appl. No.: 10/226,899

(22) Filed: Aug. 23, 2002

Related U.S. Application Data
(63) Continuation of application No. 09/280,212, filed on Mar. 29, 1999, now abandoned.
(60) Provisional application No. 60/098,954, filed on Sep. 3, 1998.

(51) Int. Cl. G06F 17/60

(52) U.S. Cl. 705/14; 705/35; 705/36; 705/37

(57) ABSTRACT

A system and method for automatically calculating and managing customer earned equity liaises several customers with merchants who wish to participate in a plan to reward a customer with earned equity credit, also termed ownership investment credit (OIC), from the merchant's stock holdings, based on a customer's completed purchase of a product or service. A merchant interface which is part of the inventive system, provides access for customers registered in the system to information, merchant brand, product/service categories, incentive program, and price, through descriptive pages which customers can browse. The merchant interface assists a customer to select a merchant, a product/service and to complete an order form. After receiving, verifying and recording the customer's purchase transaction, the merchant interface sends information to a registration and transactions database. From inputs received from the registration and transaction database and based on merchant equity credit calculation rules recorded in the system, a customer's earned equity credit is automatically calculated, stored in an equity credit database and further processed for redemption by the customer, based on redemption rules in the system and based on customer choice. A customer's earned equity credit information may be sent by the system to a stock broker to initiate purchase of stock for the customer. The equity credit calculation rules might include considerations such as customer's purchase volume, customer being a new customer, and payment by customer within terms. The merchants might be selling products or providing services, and could include, without limitation, those dealing in long distance telecommunications, credit card services, gasoline, cable/satellite TV service, Internet service, automobile leasing, mutual finds, bonds, stock funds, or entertainment.

### RELATED APPLICATIONS

This application claims the benefit of U.S. Provisional application serial No. 60/098,954, filed on Sep. 3, 1998, the contents of which are incorporated herein by reference.

### BACKGROUND OF THE INVENTION

Incentives for patronage wherein customers/consumers are encouraged to buy more and more of whatever product/service a merchant has to offer are known in prior art. A well-known example is frequent flier miles completed up to a stage where if the accumulated miles reach a predetermined limit (e.g., 50,000 or 100,000 miles) the user is then entitled to a free flight within a defined distance radius.

A second well-known example is the incentive provided by certain credit card companies to encourage use of the credit card by a customer, wherein the customer accumulates points based on the dollar value of the credit used. The points are redeemable for purchase of items from a predetermined list maintained by the credit card providers, or can be applied towards the cost of vacations, for example. Alternatively, the accumulated redeemable points can be converted into cash coupons which can be applied or used for future purchases.

Yet another example is a well-known GM® card, which provides its users with 5% earnings on purchases made using the card, with a $500/year cap on earnings. The accumulated card earnings are redeemable on the purchase or lease price of new GM® cars and trucks. The parameters to be considered by the card provider in such an arrangement are simply that there is a cap or ceiling on the 5% earned amounts for calendar year, and that the only way the accumulated card earnings can be used by a user is to purchase or lease a new GM® vehicle.

Prior art includes examples whereby a user is rewarded for using certain services or making purchases on-line, or even for paying attention to an advertisement.

### SUMMARY OF THE INVENTION

The general concept of the present invention took shape in 1997 from research into customer acquisition and retention strategies being used by the telecommunications industry. These strategies usually employ some form of rebate or promotional “currency” as an incentive for new or continued patronage. Frequent flier miles, concert tickets, even checks for $100 were being distributed, often yielding disappointing acquisition results as well as poor retention.

In September, 1997, the assignees of this invention commissioned a national survey, conducted by the Townsend Group, of 600 respondents interviewed by telephone. The sample was controlled for gender to ensure an even distribution of men and women. The results were deemed accurate by the survey group within a margin of error of ±4 percent.

The survey, entitled “Equity Investment Program as a Means to Attain and Secure Long Distance Telephone Subscribers”, was presented on Oct. 6, 1997.

The present invention resides in a system and method for calculating and administrating offering of equity grants and earned equity incentives to customers who consume products or services offered by a provider, based on several factors including the consumption of products and services by the consumer.

Prior art systems known hitherto where a customer is rewarded for a purchase, are relatively simple and do not need to take into consideration any account balance or payments by the user, nor the calculation of any customer equity grants and/or earned equity credits (equity grant/earned equity commerce).

Generally, offering a reward or some kind of an advantage or benefit to the buyer or consumer for the business transacted by the consumer, is a palatable idea for the consumer, and a marketing tool for the provider. Additionally, the idea that a consumer can own a piece of the business of a provider from whom the consumer buys a commodity or service is a highly attractive proposition for the majority of the consumers. It is recognized that the extent of interest which a consumer or buyer can own in a provider's business should, among other things, depend on the magnitude of purchase or the rate of consumption of the service consumed on an ongoing basis. This concept has led to the creation, by the inventors, of a unique promotional currency called Ownership Investment Credit (OIC), which enables consumers to build an equity stake in the provider's business. Examples of such providers are:

Long distance telecommunications;

Credit card services;

Gasoline;

Cable/satellite television service;

Internet service;

Automobile leasing;

Entertainment;

Mutual funds, stock funds, and bonds;

and many more The OIC incentive is doubly attractive to consumers since it offers growing equity ownership in major corporations for expenditures that are already committed in every household budget.

The OIC incentive is much more powerful than traditional forms of customer incentive such as rebates, discounts, and frequent flier miles. Rebates require customer action (usually delayed) for redemption. Discounts are often assumed by the customer to represent the true price of the good or service. It is said that frequent flier miles, now more than 20 years old, are over-offered and under-used. They are also subject to increasing restrictions on their redemption. None of these, or other forms of buyer incentive or loyalty programs have the attraction of ownership. The value of the OIC will be instantly perceived by the consumer. Building an equity stake in a number of major corporations offers a pathway in the direction of financial security, the most powerful incentive of all.

This invention is directed to a system wherein the OIC can be used by the consumer to obtain equity grant and earned equity credit. The present invention provides a processing system, and method of data processing for causing consumer equity granting and consumer earned equity interest in patronage commerce. By this invention, an offering company grants a slice of its equity and stock to the consumer in correlation to the individuals consumer's patronage as measured by the consumer's consumption of products, services, and promotional alliance offerings of the offering company. A consumer can earn OICs, for example, as a percentage of the consumer's purchase. Based on the earned OICs, shares in the offering company's stock can be purchased by a brokerage house and held in the consumer's account, as directed by the assignee company, for example. Several considerations such as consumer's transaction data and customer's response to company's promotion type offerings can additionally be taken into account as parameters while figuring out the equity credit which a consumer will be earning from time to time. The use of the method, data processing system, and apparatus of the present invention has application in the offering of consumer services and products such as consumer utilities services, gas and electric, consumer communications services, such as telephone services, cable services, and Internet services, and the offering of consumer products, both durable and non-durable goods, as well as the ability to make available the offering company's equity credits to other companies to use in the promotion and sale of their goods and services under promotional alliance agreements.

The assignee, through a website, might offer a variety of unique services, special offers that include bonus OICs, examples of equity-building potential for typical merchant goods and services, and an incentive OIC calculator, which shows the value of the consumer's personal OIC portfolio based on the previous day's closing stock prices. In addition, consumers might use the website as an Internet gateway since it will also include such Internet functionalities as e-mail, access to search engines, personal productivity tools, news, and other valuable content. The assignee website will be a powerful marketing and advertising medium for the participating merchant companies. It will also be a source of valuable consumer data.

Consumers can become members of the system operated by the assignee through the website and/or mail or call center by filling out a registration form and selecting the merchant company programs in which they wish to participate. New merchant companies will be added on a regular basis. Merchant companies may also solicit members through their own websites and promotional material. Merchants and providers, by associating with an assignee or license could derive a variety of benefits including:

Increased market share;

Customer retention;

Creation of new shareholders;

Enhancement of equity value; and

Source of customer purchase and demographic data.

Merchant companies and other providers can benefit directly by the addition of new customers seeking the equity grant and earned equity credit commerce and by the conversion of existing to customer/owners to ensure competitive preference and customer retention.

This invention generally provides a liaison system and method for calculating and managing customer earned equity in the seller's ownership equity, based on the customer's purchase.

More particularly, in electronic commerce or in an Internet setting where a customer can buy a product or a service from a selected merchant on-line, the invention provides a liaising system between the customer and the merchant provider for automatically calculating, managing, and selectively administrating customer earned equity.

In its broad form, the invention resides in a method, and a system for automatically calculating customer earned equity stock in a merchant's/provider's ownership equity based on purchases made by the customer with the merchant/provider, comprising a merchant interface which receives, verifies, and records a customer's access/registration information and transaction fulfillment information, means for generating signals indicating completion of a purchase transaction and payment therefor; means storing merchant's/provider's equity credit calculation and equity conversion and redemption rules; and a processor coupled to a software program which responsive to said signals and said equity conversion and redemption rules generates calculated equity credit information which indicates equity stock earned by the customer for purchase made through the purchase transaction.

The invention, in another form, resides in a system and method for liaising a plurality of customers with a plurality of merchants/providers, with the object of automatically calculating and managing customer earned equity based on customer's purchases from a provider. In electronic commerce where customers on line can select a merchant and an offered product/service/promotional deal for purchase, and wherein a selected merchant wishes to participate in a plan to reward a customer with earned equity credit from the selected merchant's stock holdings, said earned equity stock being commensurate with customer's purchase, the invention provides a method for liaising a plurality of customers as potential purchasers with a plurality of merchants who wish to participate in and be part of the system, for automatically calculating and managing customer earned equity, said method comprising the steps of: enabling said plurality of customers and said plurality of merchants to participate in the system; offering access to any of said plurality of customers to participating merchants' information including available products, services, promotional deals and their corresponding prices; storing merchants' equity credit calculation rules and equity redemption rules; and using a processor including a software program for automatically generating calculated earned credit equity information for a single customer, based on said credit calculation rules and equity redemption rules as well as said single customer's completed purchase information.

In a modification of the system, the merchant interface includes means to allow a customer to obtain information pertaining to several merchants by browsing merchant data and merchant's product/service data.

In order for the system and method of the invention to serve to liaise a customer with a merchant/provider, it is preferable that both the customer and the merchant are affiliated with the system provider. If not already affiliated, the customer can become affiliated with the system provider. Likewise, the merchant can become affiliated too.

### BRIEF DESCRIPTION OF THE DRAWINGS

The foregoing and other aspects and advantages of the invention will be apparent from the following more particular description of preferred embodiments of the invention, as illustrated in or described with reference to the accompanying drawings in which emphasis is placed on illustrating the principles of the invention, and wherein:

FIG. 1 illustrates an overview of the system/process of a preferred embodiment of the present invention;

FIG. 2 illustrates diagrammatically a new customer/owner registration unit from FIG. 1;

FIG. 3 illustrates a customer/owner access arrangement in the practice of the present invention;

FIG. 4 is an illustration of a merchant interface from FIG. 1;

FIG. 5 is an illustration of the customer equity calculation process using the invention;

FIG. 6 is a schematic of a customer equity credit redemption process;

FIG. 7 is an overview of an operating system using the present invention;

FIG. 8 is a data flow and processing routine overview using the invention;

FIG. 9 is an overview of a customer equity partnering commerce operating system model;

FIG. 10 is a flow diagram of an equity transfer processing unit according to the invention;

FIG. 11 is a flow diagram of and equity credit conversion processing unit;

FIG. 12 shows the functional interaction of elements of the inventive system;

FIG. 13 shows the functional interaction of elements of a modified inventive system;

FIG. 14 illustrates a customer database and central repository used in the invention;

FIG. 15 shows a sample customer masterfile used in the invention;

FIG. 16 shows an exemplary calculating platform used in the invention;

FIG. 17 shows calculation platform processes as used in an embodiment of the invention; and

FIG. 18 shows an exemplary customer masterfile through the calculation process.

### DESCRIPTION OF PREFERRED EMBODIMENTS

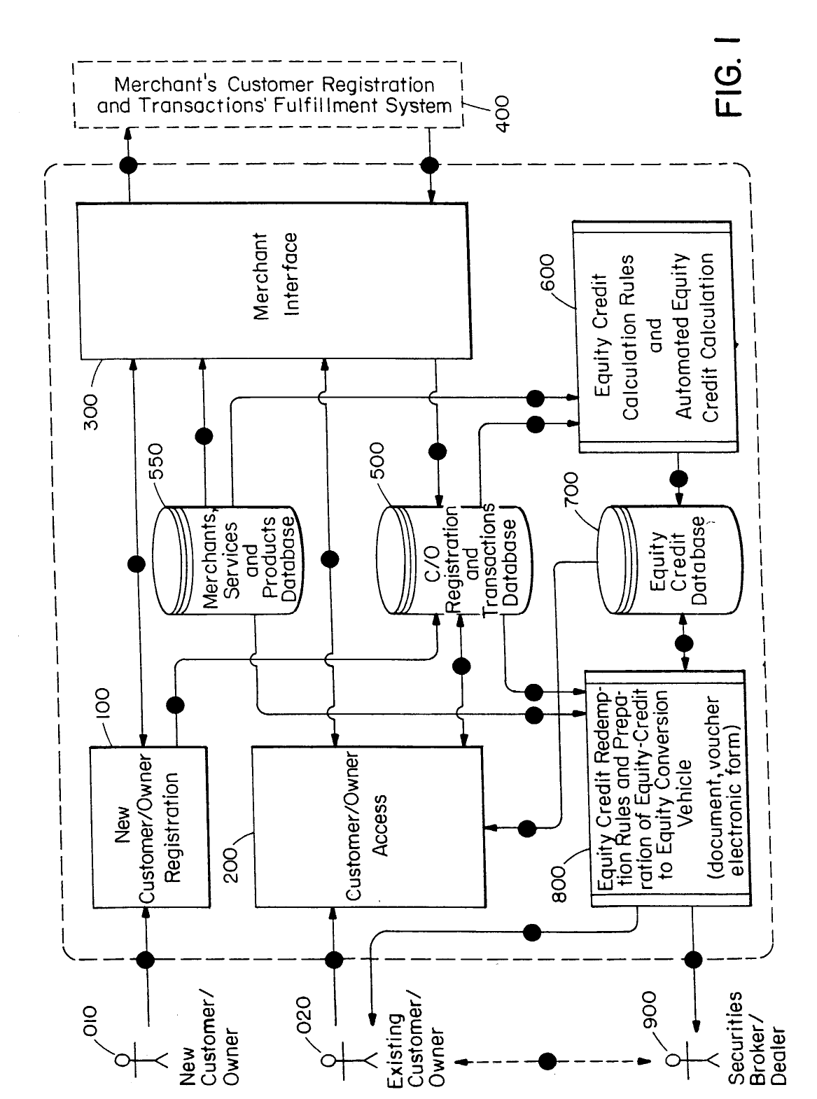

FIG. 1 illustrates diagrammatically a system and a process overview of an embodiment of the invention showing earned equity incentive driven commerce. The illustrated system is intended as a bridge between users/customers on the one hand, and merchants/providers on the other.

For a new customer 010, the incentive process/system 101 provides for registration at 100 which is transmitted as information to both the registration/transactions database 500 and into a unit 300 which interfaces with merchant's customer registration and transaction fulfillment unit 400 which may be outside of the system 101. Parallely, unit 200 handles and screens access to the system from those who are already customers. Information entered by customers is likewise transmitted to units 300 for processing, and to database 500 for storage. The purchase and delivery aspects of a transaction from a new customer or an existing customer are handled at the unit 400, which is controlled by the concerned merchant. Notwithstanding, information to the effect that a purchase has been made and the payment therefor authorized, is transmitted back from unit 400 to 300. Database 550 receives inputs from unit 300 and also stores information relating to the merchant's products and services. Output information from both the databases 500 and 550 is made available to unit 600 which has a program to make automated equity credit calculation and generate earned equity credit information. It is also possible to obtain reports from databases 500 and 550 to obtain any required information or details regarding customers and/or merchant services and products. The program within unit 600 takes into account all the parameters which the provider of system 101 intends to be considered before making a calculation of equity credit or automated equity credit.

Examples of parameters (for any customer) which might be considered by unit 600 include product sales, service usage, acquired promotional equity credits, account balance, and payments and other data elements. Unit 600 also holds calculation capabilities necessary to process consumer equity grants, the allocation and award of earned equity credits, the conversion of equity credits and transfer of offering company equity to the consumer customer. Unit 600 generates updated equity credit information which is stored in database at 700. From database 700, a feedback line is capable of transferring information to either an existing customer or a newly registered customer, as the case may be. Unit 700 also generates an output received by unit 800 to prepare suitable equity credit information to equity conversion documents which may be in the form of a hard copy voucher, or a record in an electronic form which is conveyed to a customer and the merchant/provider, as well as a securities broker/dealer as shown at 900.

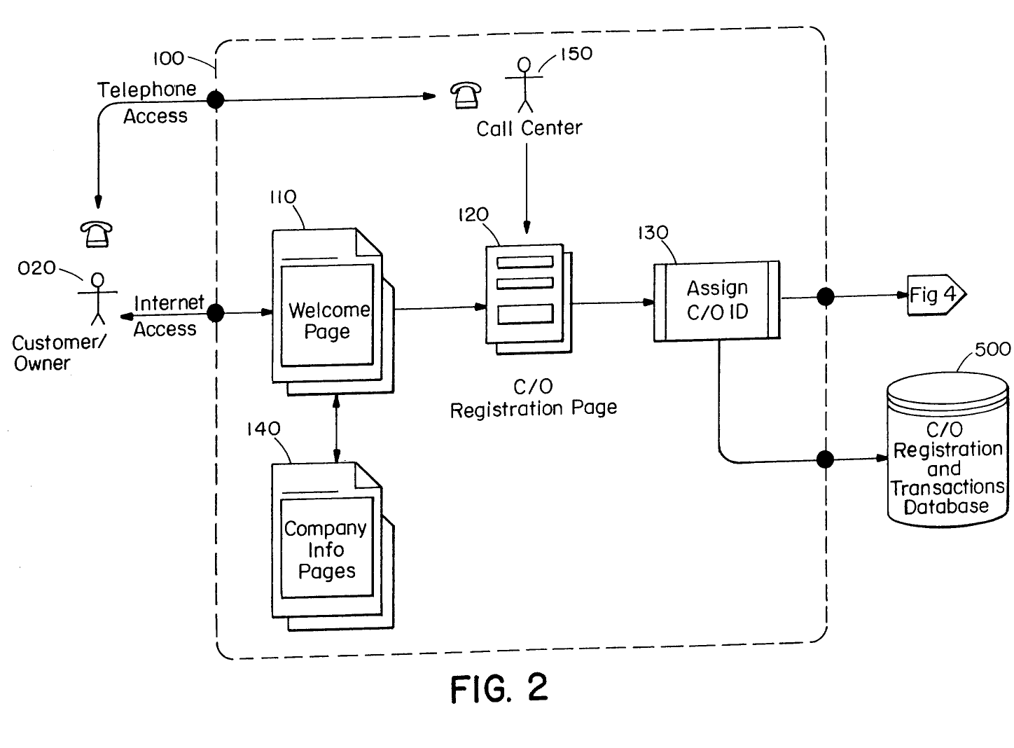

FIG. 2 illustrates a functional layout of a new customer/owner registration module 100 from FIG. 1. A customer who is a potential owner of equity interest in a merchant firm obtains telephone and/or Internet access to a call center and/or welcome page 110 respectively. The customer is led to the customer/owner registration page where the customer provides the registration information. A customer identification number or code is assigned at 130 to a new customer. The customer identification is sent to a customer registration and transactions database 140.

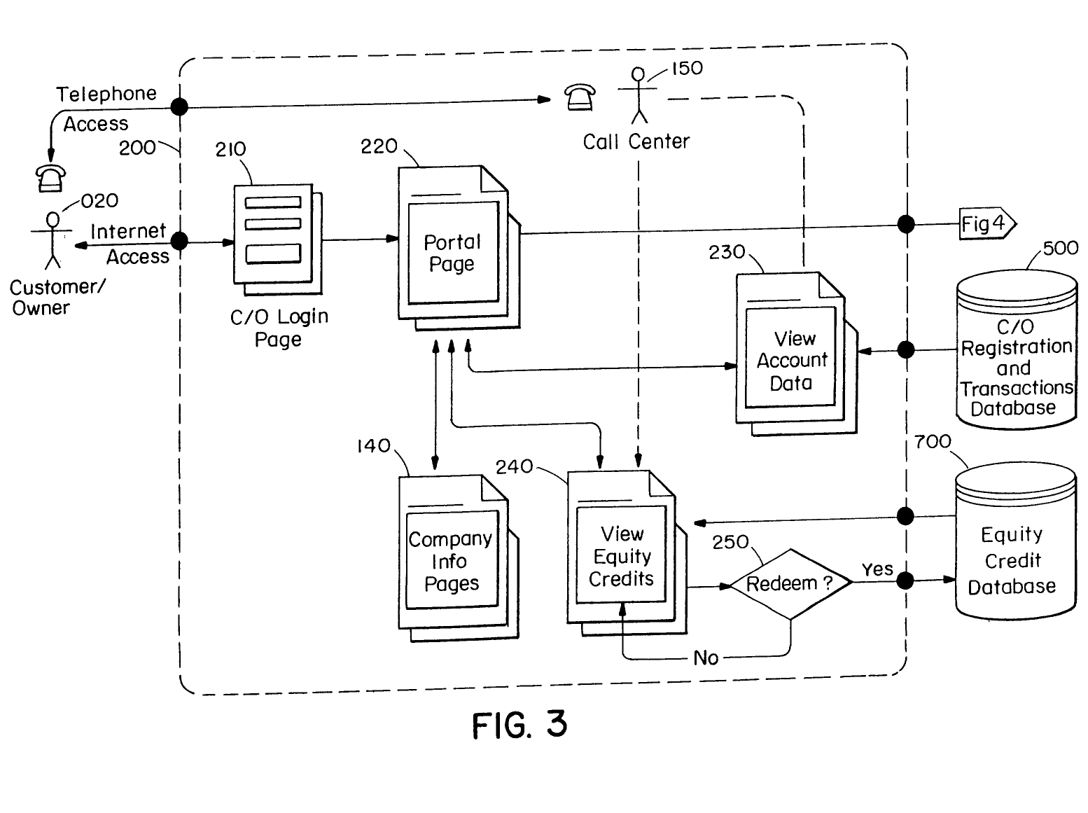

FIG. 3 illustrates a customer/owner access unit 200, which includes a login page 210, portal page 220 and a call center interface 150. Block 230 provides a view of account data. 140 houses company information pages. Unit 240 lets the customer view the earned equity credits, and if the customer desires to redeem the credits, information is sent to the equity credit database 700.

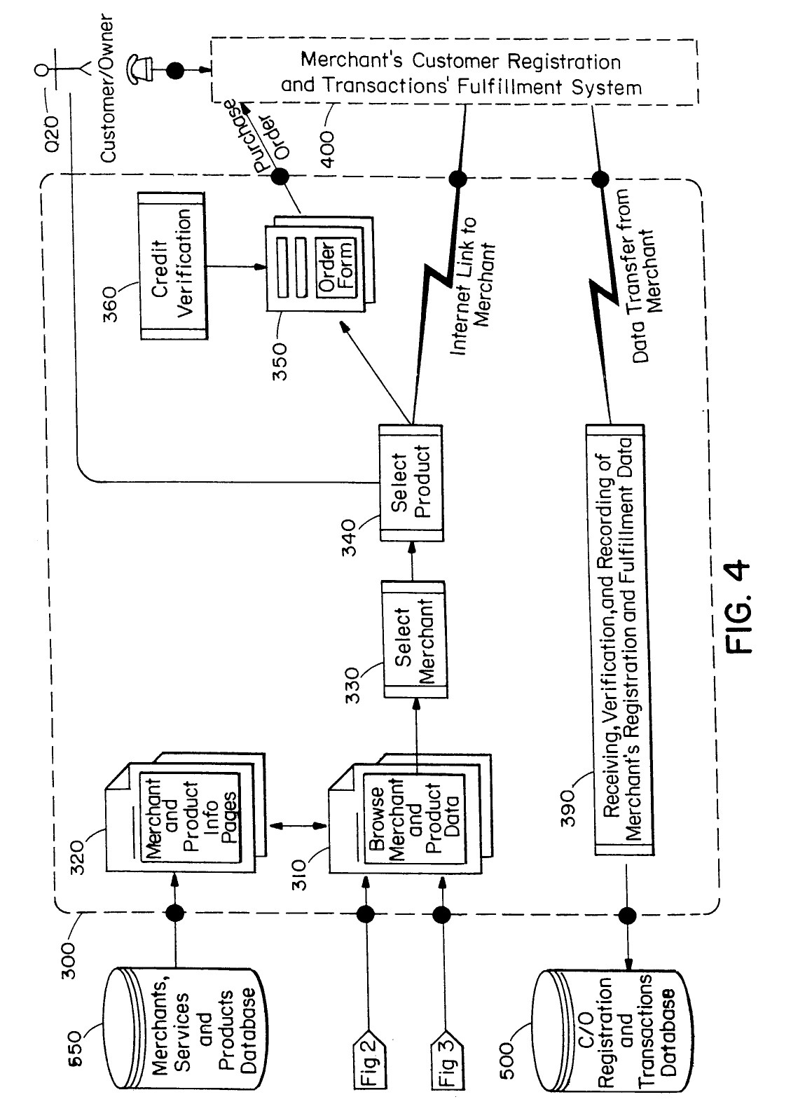

FIG. 4 illustrates a merchant interface 300 of FIG. 1, which shows the access to a customer for merchant and product information/data as shown at 310 and 320. Thereafter, a customer gets to select a merchant and a product to be purchased as shown at 330 and 340 respectively. From block 340, an order form 350 is completed and a credit verification is done as shown at 360. Simultaneously, signals are sent to enable the merchant's customer registration and transaction fulfillment as shown at 400. At 390, the merchant's customer registration and transactions fulfillment information is received, verified and recorded. Database 500 holds in memory all information regarding customers' registrations and transactions. FIG. 4 also shows a customer/owner calling via telephone direct to merchant and then being included in data transfer system from merchant.

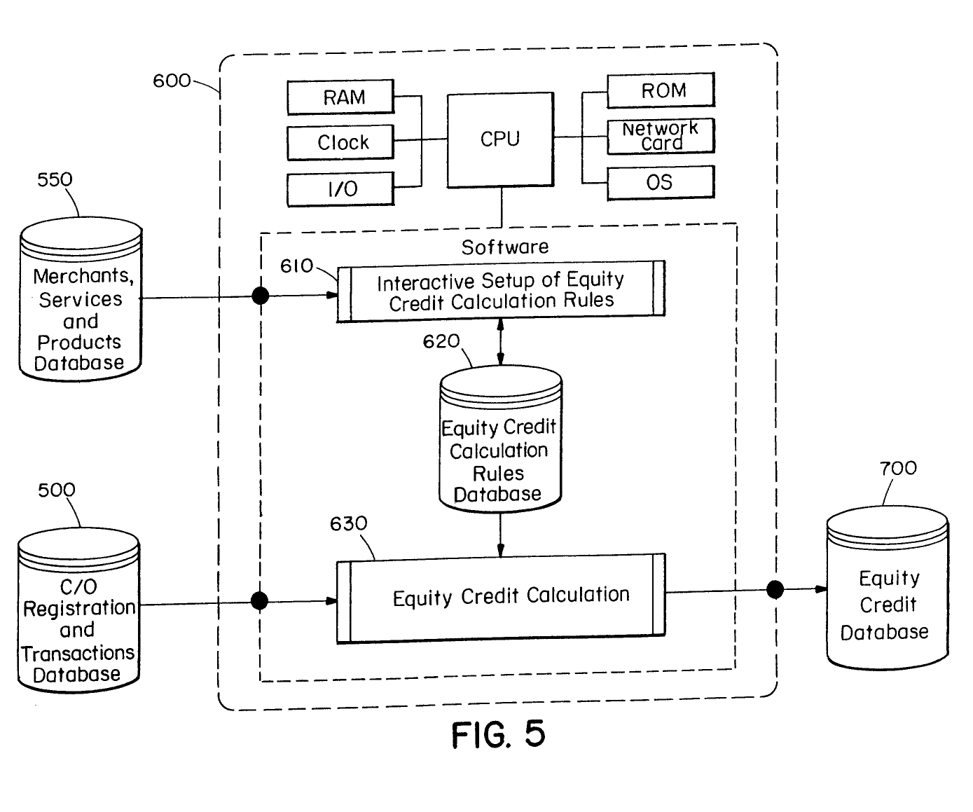

FIG. 5 shows at 600, an equity credit calculation process using the invention, which may use a CPU, RAM, ROM, clock, network card, and I/O interface as needed, as well as a software program which by using an interactive setup of equity calculation rules, computes the customer equity credit for each purchase made from a merchant/provider wherein the merchant/provider has agreed to allot earned equity stock to a customer based on purchases made by the customer. Information so generated is updated and is held in memory in the database 700.

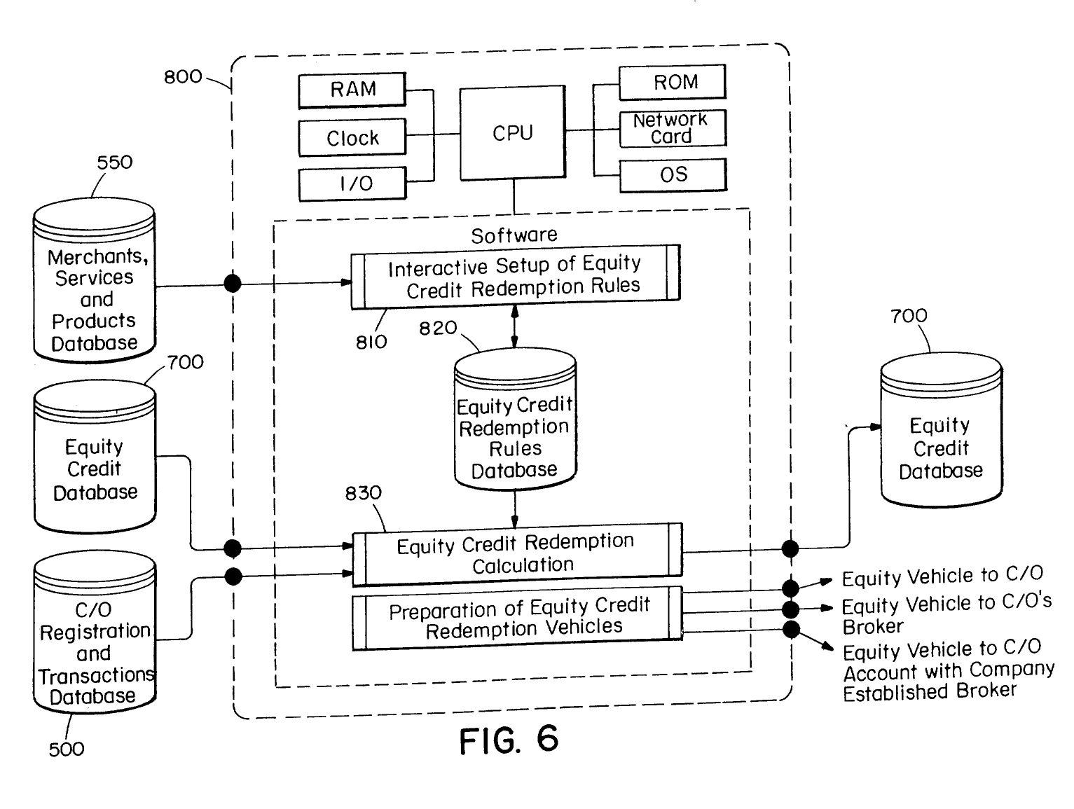

FIG. 6 illustrates at unit 800 the equity credit redemption process using the invention. Unit 800 incorporates software and other elements such as a CPU, RAM, ROM, network card, and a clock. It includes an interactive setup of equity credit redemption rules as shown at 810. 820 is an equity redemption rules database. The equity credit redemption calculation is performed at 830, as well as the preparation of equity credit redemption vehicles as well as notification to merchant and brokerage house and customer/owner (e.g., voucher or an electronic document).

Process Narrative of an Exemplary Embodiment of the Inventive System:

The process begins with a new customer 010 entering the system via one of numerous methods. First, a new customer 010 may reach via telephone (A) our call center, via an Internet connection or through a merchant's call center, mail or Internet presence 150 a page where a user may enter customer information including name, address, contact information, social security number and user preferences resulting in a unique identification code and password being issued 130. A potential customer may also enter the system via an Internet connection and browser such as Netscape navigator or Internet explorer (A) and arrive at the Welcome page 110. The user will have the option to browse pages for further company information and advantages, required Securities and Exchange Commission (SEC) disclosures and equity accumulation illustrations 140, or proceed directly to the registration page 120. From all pages a link is provided to the registration page where vital information can be entered into a secure environment, submitted and a unique user identification (ID) and password will be assigned at 130. Access to this routine will also be provided via member merchant's web sites, mail processing center and customer service departments. In all instances, the customer/owner's information, ID and password will be stored in the Customer Registration and transaction Database 500.

(In all Internet routines it is assumed user will have the ability to backtrack from any particular point in the program. Also user will have the ability to return to the selection menu as well as have the ability to exit program at any time during all further steps even though this is not constantly repeated. It is also common that a customer service and call center will have the ability to interact and access all data and routines.)

The user will then have the option to proceed directly to the merchant interface or proceed as other existing registered customer owners would, via a login page 210 which will be an optional security feature to restrict access to personal portal page 220. Elements of the portal page will include links to company pages 140, View and manage stored earned equity credits 240, trigger the redemption of qualified credits 250, view and manipulate account registration information and preferences, and links related to the merchant interface in addition to stock portfolio functionality.

The merchant interface section of the portal 320 will display choices by merchant brand and product information categories. From this point the user can use the browse option to either view stored product data and program description pages 310, or follow links directly to the individual merchant's web sites for more detailed information on the merchant or programs/services offered. The browse option will allow the user the ability to display the products and services in a variety of ways; for example, they may want to view merchants alphabetically or they may opt to view products by assigned criteria via a “boolean” search string to enable easier product or service comparison. Each particular merchant may have numerous product offerings and levels of services and incentive programs which will result in numerous pages to view and scroll through depending upon the amount of information the customer requires for making a decision. If the user decides to purchase a product or service, a merchant is selected at 330, then a product is selected at 340. From this point merchant fulfillment may be handled in one of many ways. The customer owner may be an existing customer of a merchant, resulting only in the need to identify himself by their unique ID number, to the merchant resulting in being included in the merchant's routine data transfer to the inventive system. Alternatively, a link may be provided to the merchant and the order can be placed electronically directly to the merchant, again resulting in a data transfer from the merchant to the inventive system database. Or, the customer may utilize an electronic order from within the system 350. Upon filling out this order form, if open terms are not offered, a credit card will be required and an electronic credit card verification routine 360 will be conducted; the credit card will be authorized and if positive, as with merchants offering open terms, a purchase order will be generated and transmitted to the merchant and any transaction information will be stored in the customer transactions database or, a customer may print an order form from merchants' pages and either submit via mail or facsimile the order directly to the merchant. In all instances including those where product orders or subscription of services are handled directly by the merchants, data on the commerce activity will be transferred from the merchants to the inventive system either by an electronic data or media transfer.

All merchant and transaction data received by system 390 will undergo such processes as receipt confirmation, verification, matching and sorting of registration and fulfillment data. Upon completion of data processing operations, this transaction data is then stored in the customer/owner registration and transactions database 500. The customer may at this point either exit the system or return to personal portal to utilize other features, or begin a selection routine of another product or service.

As the transaction data is reported to database 500 of the inventive system, batches of data undergo the equity credit calculation process 630. The program calls the specific equity credit calculation rules 620 unique to that merchant's services or products transactions and the calculation is performed resulting in equity credits in the equity credit database 700. For example, purchase activity with merchant A may have been $100 for user JQ99, and this sales volume will be calculated to result in X number of credits being issued based upon pre-defined merchant criteria and parameters. Some exemplary merchant criteria would include:

Sales Volume X a fixed percentage=X Equity Credits

New customer=Award X additional Credits and/or

Sales volume>X=XX in credits and/or

Sales volume>Y=YY in credits and/or

Sales volume>Z=ZZ in credits . . . and/or

P credits if paid within terms, R if not and/or More . . .

As the equity credits are calculated at 600, and recorded, batch data will be matched to additional criteria 820 and 500 to determine credit redemption eligibility and to assign a status to those credits. These additional criteria for example may relate to (a) certain purchase or commerce volume (b) length of time a customer has been active with that merchant (c) that a certain number of credits be accrued since last redemption of credits, or (d) credits may become available immediately. If result is automatic redemption or if customer has activated a redemption routine, again, additional merchant data is queried, a redemption vehicle is prepared and delivered as a notification to the customer. Results again are stored in the equity credit database 700 and/or the customer/owner registration and transactions database 500.

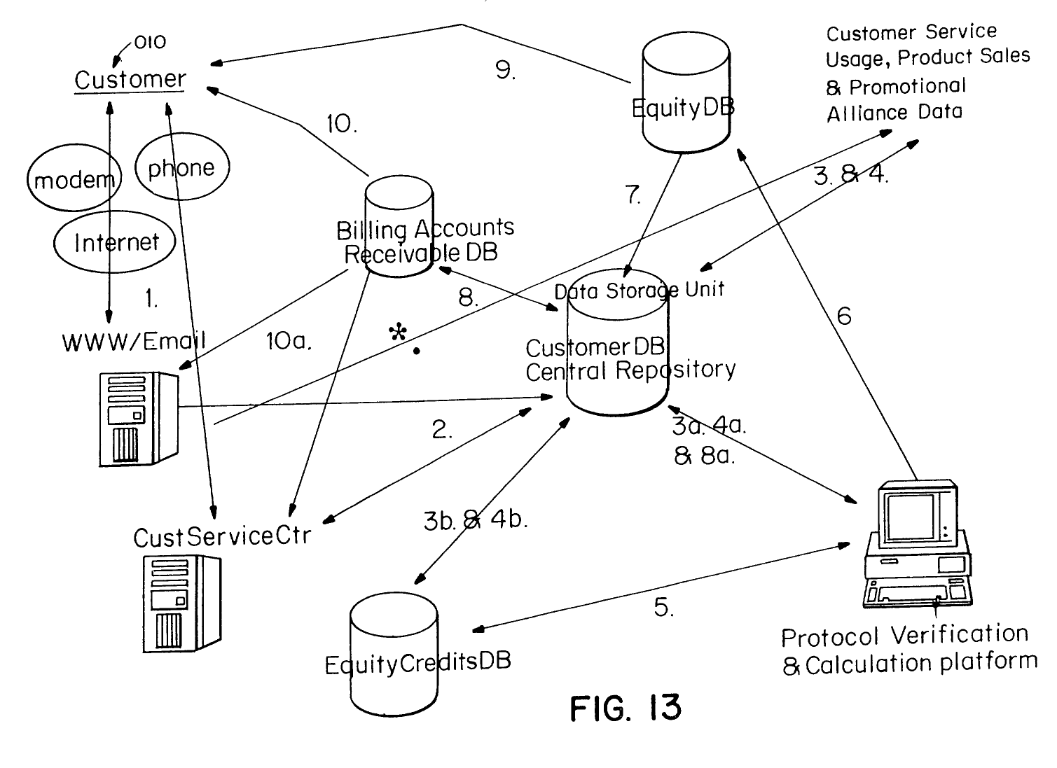

Another View of an Example of the Inventive System Process with Reference to FIG. 13 may be Presented as Follows:

1. The Web Server or Customer Service Center of the inventive system receives a request via voice, postal service, delivery service, web browser or email message for the purchase of a product or service or promotional offer.

2. The Web Server or Customer Service Center of the inventive system notifies the Customer DB of customer transactions and the related service, product or promotion order.

3. Order information is transferred to service, product or Promotional Alliance contractor for fulfillment of customer transaction(s).

4. Customer order direct to service, product or Promotional Alliance contractor for fulfillment of customer transaction(s) via cryptographically secured network interface.

3a. Customer order data to Central Processing Unit (CPU), Protocol Verification and Calculation platform. Customer order data compared to Equity Credit types and corresponding acceptance protocol parameters. Equity Credit type, status and calculations performed, Equity Credits Awarded, Assigned or denied.

3b. Customer Equity Credit Data to Equity Credits Database and Customer Database masterfile.

4. Customer service usage, product and promotion fulfillment data to Customer DB.

4a. Customer service usage, product and promotion fulfillment data to Central Processing Unit (CPU), Protocol Verification and Calculation platform, update Equity Credit status in Equity Credits Database per applicable protocol parameters.

4b. Assigned and or awarded Customer equity credits in Equity Credits Database, updated based upon usage and fulfillment data calculations per applicable protocol parameters. Data update revision to Equity Credits Database and Customer Database masterfile.

5. The Central Processing Unit (CPU), Protocol Verification and Calculation platform compares Credit Equity DB customer equity credit data to protocol parameters on occurrence of data file change and on a scheduled basis. Awarded Equity Credits eligible (meeting of all EC type protocol parameters) for conversion and transfer assessed.

6. Awarded eligible Equity Credits conversion calculated in Central Processing Unit (CPU), Protocol Verification and Calculation platform per equity credit type conversion parameters. Equity Vehicle type and volume information to Equity Database.

7. Equity transfer data to Customer Database masterfile.

8. Service, usage, product sales, promotional alliance, equity credit, equity data to Billing Accounts Receivable Database.

8a. Equity transfer data to Central Processing Unit (CPU), Protocol Verification and Calculation platform for equity credit update, and update to merchant and brokerage house.

9. Equity transferred to Customer.

10. Billing/Invoice/Statement to Customer.

10a. Account balance information to both the World Wide Web (WWW) server and the Customer Service Center.

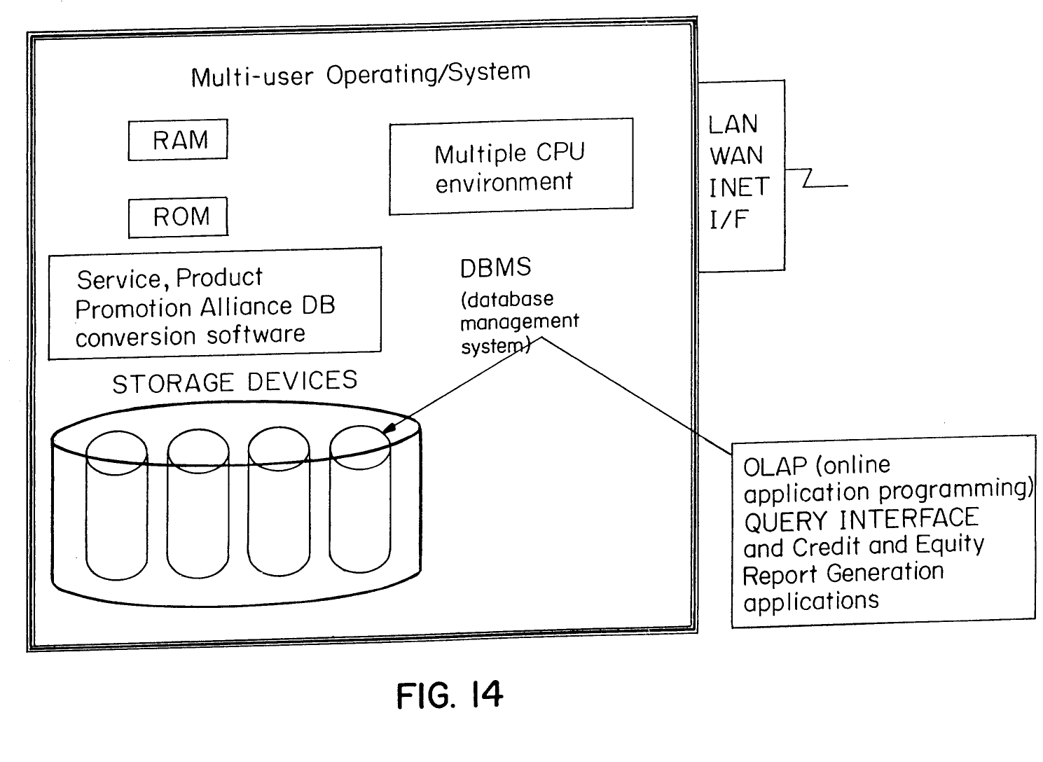

Customer DB and Central Repository (see FIG. 14)

The central repository of data for the preferred system preferably consists of server-based technology that will support a symmetric multi-processing environment. An RDMS (relational database management system) may be used to control the organization and access of the customer masterfile.

On-line query to the database may be supported through an OLAP (on-line application programming) tool. This interface will be used to support all inquiries and report generation through a desktop GUI (graphic user interface).

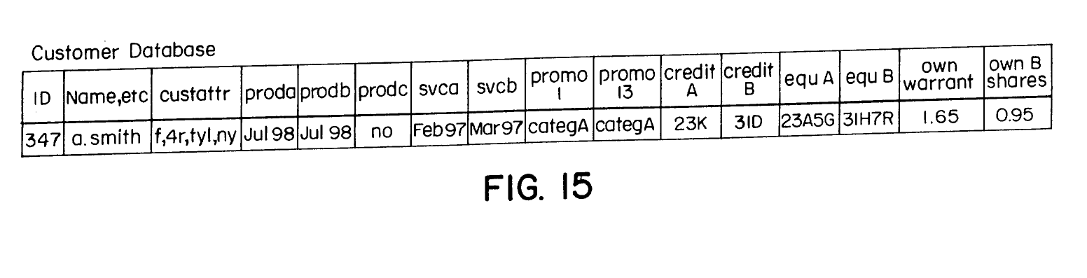

Customer Masterfile (see FIG. 15)

The Customer Masterfile preferably resides in the Customer DB and maintains a comprehensive record for each customer.

Each customer record preferably includes fields for:

Customer specific information

name, address, etc.

attributes

e.g. socioeconomic factors

ownership or participation in every product, service, and promotion offered

related equity credit and equity information

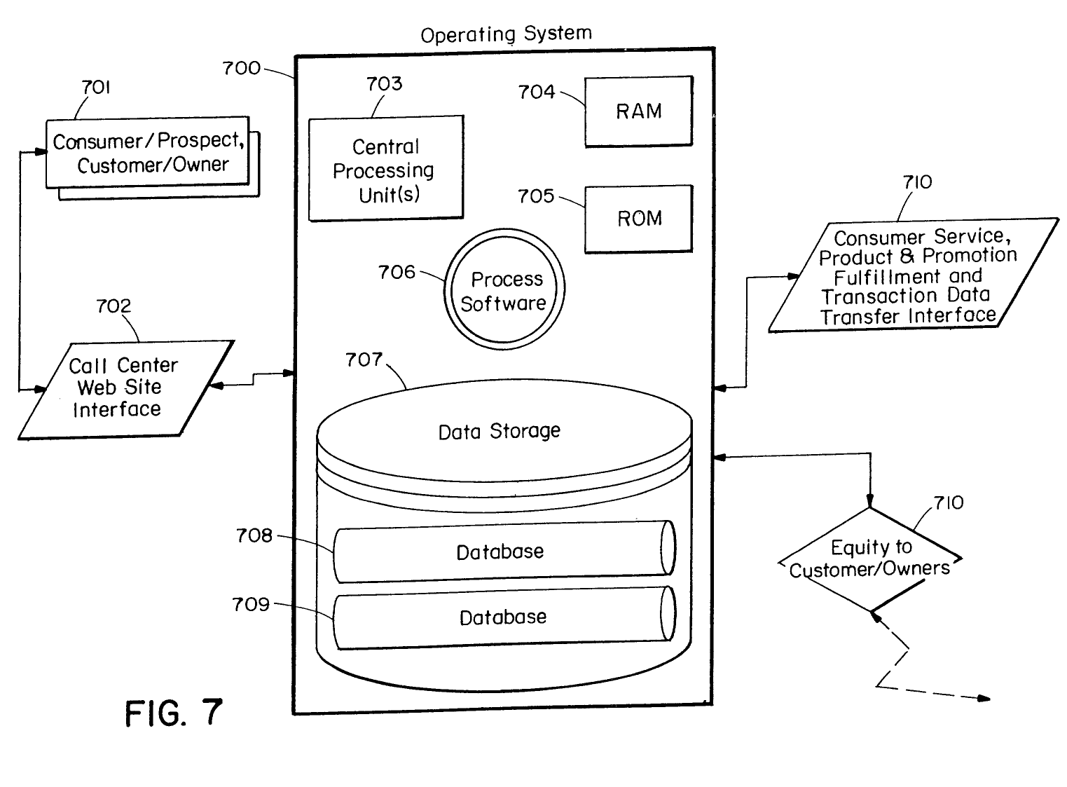

FIG. 7 generally shows a simple diagram of an operative system 700 of the invention, showing consumer 701, website interface 702, CPU 703, RAM 704, ROM 705, process software 706, data storage 707 and databases 708 and 709.

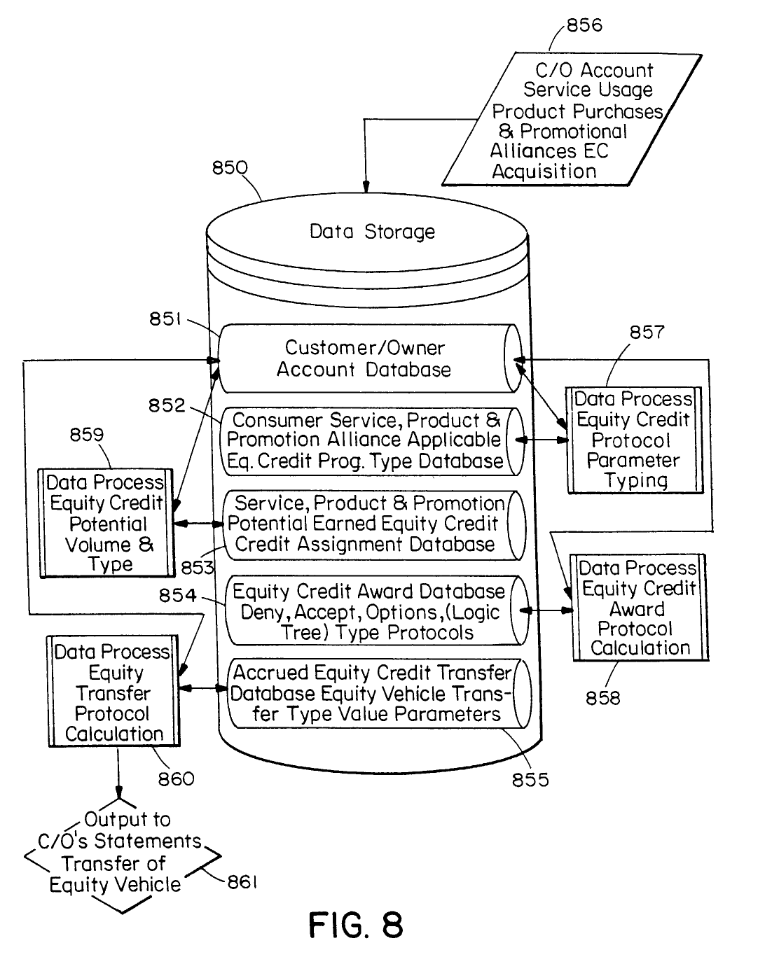

FIG. 8 shows a data flow and processing routine overview which includes data storage 850 which comprises customer/owner account database 851, consumer service and promotion alliance, applicable equity credit program type database 852, service product and promotion, potential earned equity credit assignment database 853, equity credit award database 854 and accrued equity credit transfer database 855. Interacting with the data storage 850 are:

1. Account service usage, product purchase and promotional alliances equity credit acquisition unit 856.

2. Data process equity credit protocol parameter typing unit 857.

3. Data process equity credit award protocol calculation unit 858.

4. Data process equity credit potential volume and type unit 859.

5. Data process equity transfer protocol calculation unit 860, and

6. Output to Consumer/Owner's Statements, transfer of equity vehicle 861.

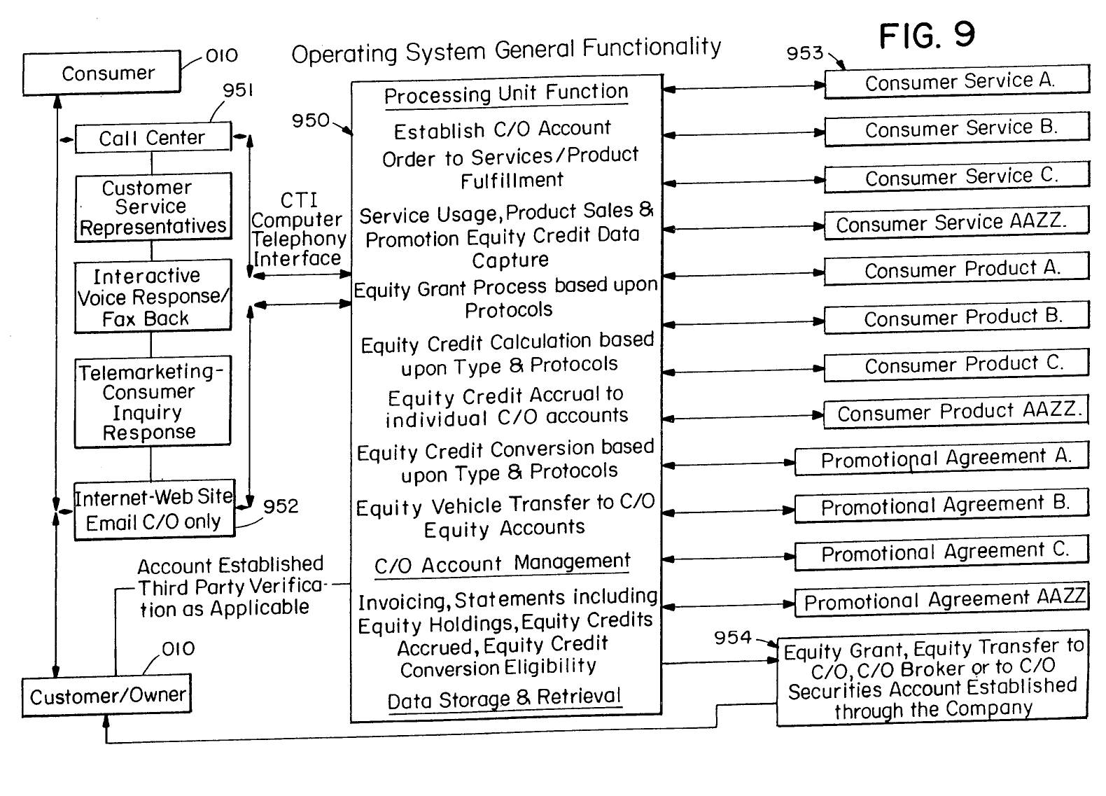

FIG. 9 illustrates an overview of consumer equity partnering commerce operating system model. It illustrates an example of how the processing function unit 950, interacts with the Consumer 010, call center 951, choice of service or product or promotional agreement represented by 953, and unit 954. Unit 954 deals with equity grant, equity transfer to customer/owner, customer/owner broker or to customer/owner securities account. Preferably and as illustrated, computer telephony interface is used to establish communication between processing unit function 950 on the one hand and call center 951/Internet website 952 on the other.

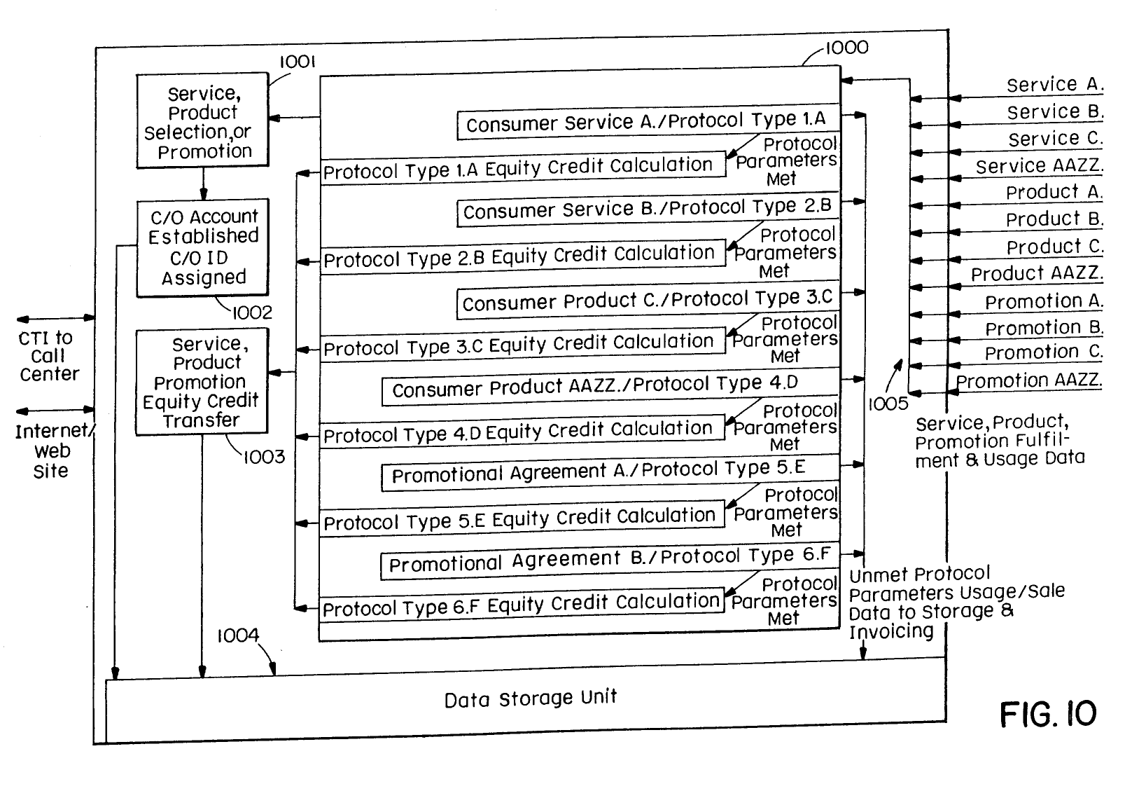

FIG. 10 illustrates functions of a processing unit which includes a data storage unit 1004 which stores information regarding services and products as well as promotional offers 1005 available for the customer. Connected to interact with the data storage unit 1004 are the functions of service, product selection or promotion 1001, customer/owner account established and identification assigned 1002, and service, product promotion equity credit transfer 1003.

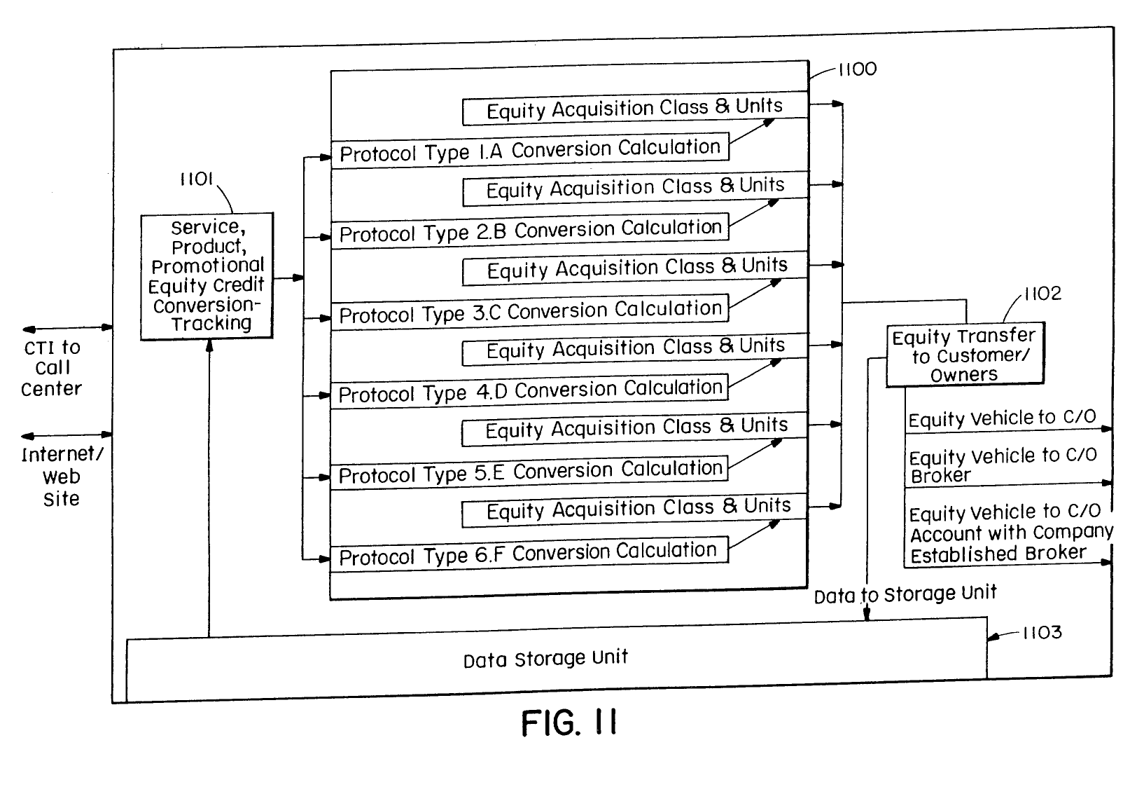

FIG. 11 illustrates an exemplary processing unit for equity credit conversion. Block 1100 as shown is capable of processing equity acquisition class and units by using a selected one of many protocols which are predefined and are in the system. An output from the processing unit representing the customer's earned equity credits is sent to the customer, to the merchant/provider, to the broker, to the customer's equity account and to storage unit 1103 as appropriate.

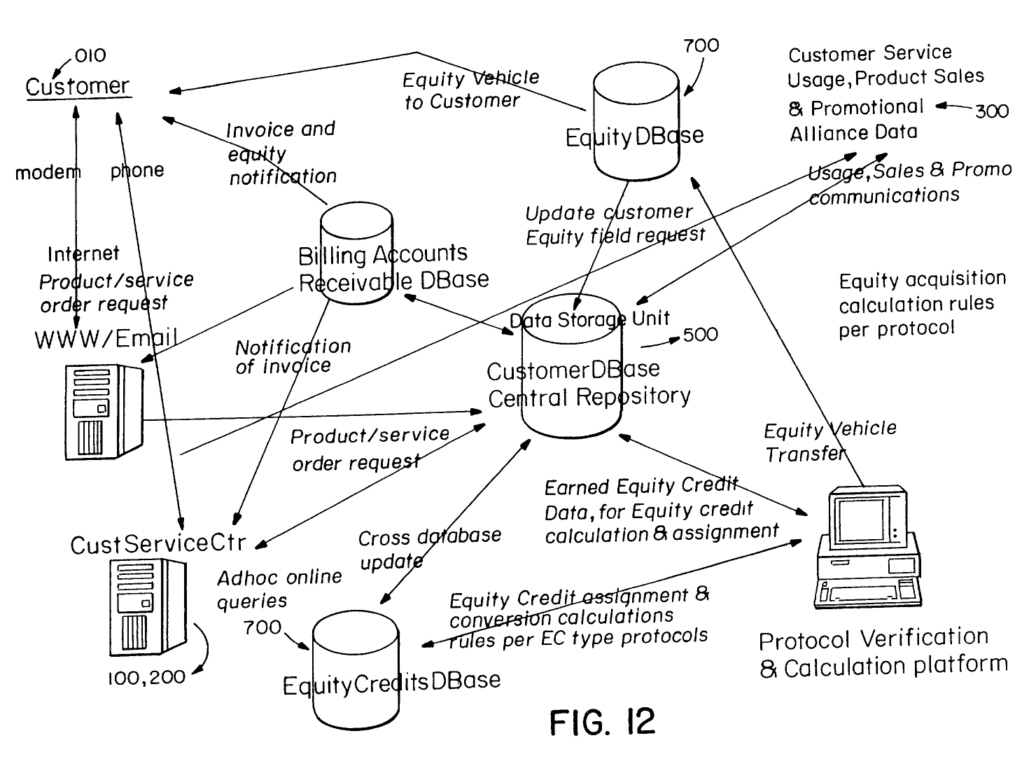

FIGS. 12 and 13 are protocol verification and calculation platform representations and pictorially illustrate a collage-like representation of differing elements of the inventive system at work.

FIG. 14 illustrates an exemplary customer database and customer repository showing the elements RAM, ROM, Database-Management System, Service, Product Promotion Alliance Database conversion software and an on-line application programming query interface.

FIG. 15 shows a sample customer masterfile showing customer's name, and products/services/promotional programs purchased by customer including credit equity and the corresponding number of shares.

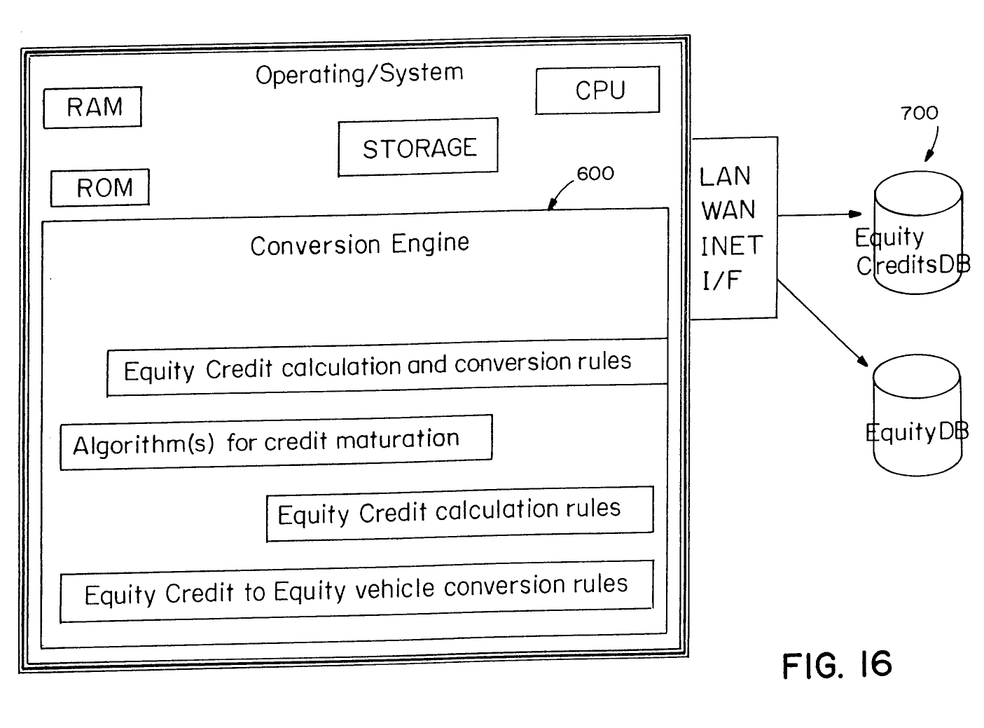

FIG. 16 shows an exemplary calculation platform which is used in the performance of the inventive system.

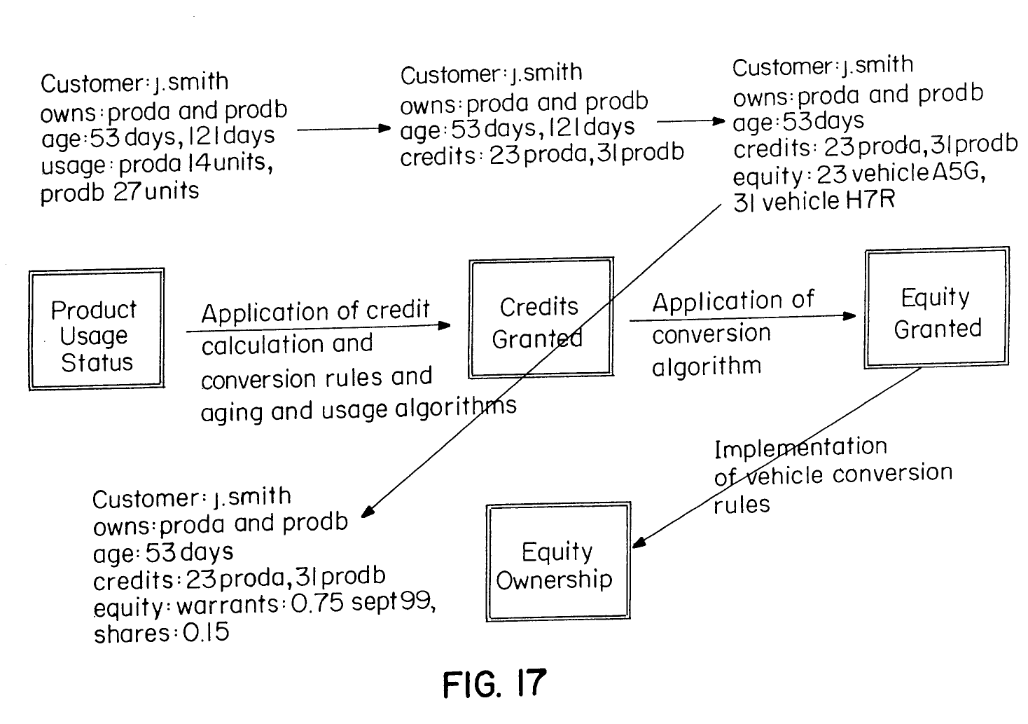

FIG. 17 shows a sample calculation platform process which can be used in the customer earned equity calculation process using the inventive system.

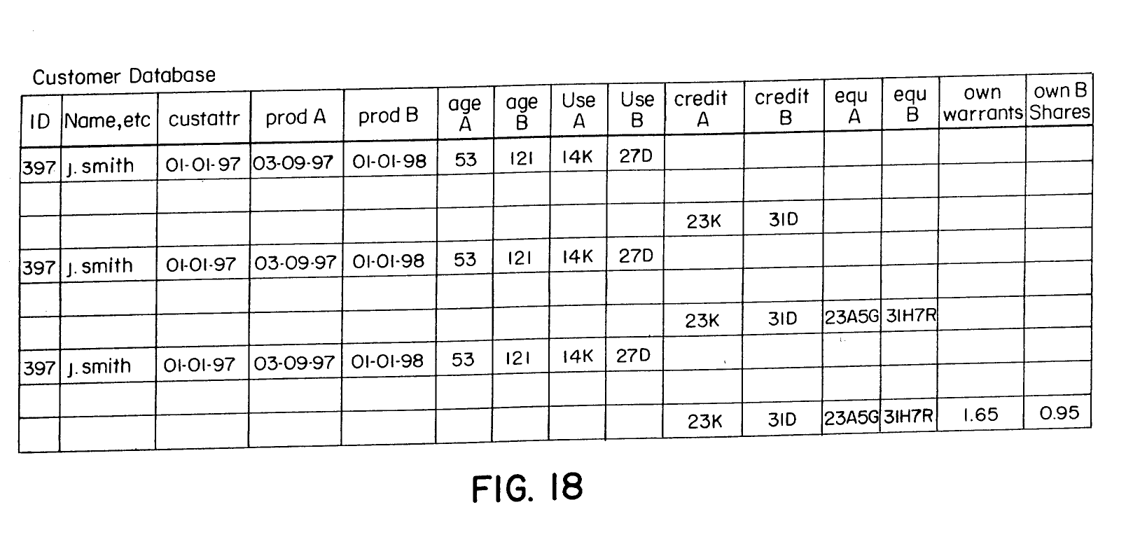

FIG. 18 shows a sample customer masterfile similar to that in FIG. 15, through the calculation process. It includes details somewhat similar to those in FIG. 15.

The foregoing description is intended to provide a detailed understanding of a system and method which could liaise several customers as purchasers with several merchants/providers, so that based on each purchase, the provider would allot certain customer earned equity credit to the purchaser. The inventive system/method described herein above, based on merchant rules, automatically calculates and manages the customer earned equity to result in purchase of stock or for redemption by the customer in any other preferred manner. It is conceivable that the invention need not be limited to customer earned equity credit. Other kinds of rewards or compensation to the purchaser are conceivable and are envisaged to be within the scope of the present invention including credits towards the purchase of bonds, mutual fund shares and/or stock, and index fund shares.

### EQUIVALENTS

While this invention has been illustrated and described with reference to specific examples and with the calculation of customer earned equity in mind, it will be understood by those skilled in the art that various changes and modifications in details and form may be made therein within the intended scope of the invention and without departing from the scope of the invention. For example, the customer's purchase may be made in person at a location where the inventive system is installed. The interfaces, databases, RAMS, ROMS and other hardware can be replaced with equivalents performing similar functions. For instance, in the flow diagram referred to hereinafter, there are references to several databases. Alternatively, data may be held in one storage device, which may be partitioned into smaller segments. Also, variations are conceivable and within the purview of the inventive concept to replace access modules, registration modules, interfaces, order forms, and other elements illustrated hereinabove. All such variations and modifications are intended to be within the scope of the invention as defined by the appended claims.

What is claimed is:

1. A system for automatically calculating a customer earned reward, based on purchases made by a customer with a merchant/provider, comprising:
a merchant interface which receives, verifies and records a customer's access/registration information and purchase transaction fulfillment information, including means for generating signals indicating completion of a purchase transaction and payment therefor;
a unit storing merchant's/provider's equity credit calculation and equity conversion and redemption rules; and
a processor coupled to a software program which responsive to said signals and said equity conversion and redemption rules generates calculated equity credit information in the form of equity stock in a merchant's/provider's ownership equity interest which indicates equity stock earned by the customer for purchase made through said purchase transaction.

2. The system as in claim 1 wherein said merchant interface includes means to allow a customer to obtain information pertaining to several merchants by browsing merchant data.

3. The system as in claim 2 including means prompting a customer to select a merchant and a product/service.

4. The system as in claim 3 further including means for receiving, verification and recording of a selected merchant's information and customer registration and transaction fulfillment data.

5. The system as in claim 1 including an equity credit database which stores, for each customer who uses the system, earned equity credit information and an identification of a merchant to whom the earned equity credit relates.

6. The system as in claim 4 wherein said means for receiving verification and recording includes means for handling merchant product/service information, customer's merchant account information, information on product/service orders placed by a customer, and transaction fulfillment information.

7. A process for automatically calculating customer earned equity stock in a merchant's/provider's ownership equity based on purchases made by the customer with the merchant/provider comprising:
receiving, verifying and recording through a merchant interface a customer's access/registration information and purchase transaction fulfillment information, generating signals indicating a customer's completion of a purchase transaction and payment therefor;
storing merchant's/provider's equity credit calculation and equity conversion and redemption rules; and
generating, using a processor coupled to a software program which is responsive to said signals and said equity conversion and redemption rules, calculated equity credit information which indicates equity stock earned by the customer for purchase made through said purchase transaction.

8. The process as in claim 7 including the step of checking and permitting a customer to obtain information pertaining to several merchants by browsing merchant data and merchant's product/service data.

9. The process as in claim 8 including the step of prompting a customer to select a merchant and a product/service.

10. The process as in claim 9 further including the step of receiving, verifying and recording of a selected merchant's customer registration and transaction fulfillment data.

11. The process as in claim 7 including the step of storing in an equity credit database, for each customer who uses the system, earned equity credit and an identification of a merchant to whom the earned equity credit relates.

12. The process as in claim 9 including the step of handling merchant product/service information, customer's merchant account information, information on product/service orders placed by a customer, and transaction fulfillment information, by using said method step of receiving verification and recording.

13. In electronic commerce which facilitates customers to choose a merchant and a product/service for making a purchase from selected ones of several merchants and products/services, and wherein a selected merchant is willing to reward a customer with earned equity stock from the merchant's equity holdings, said earned equity stock being commensurate with customer's purchase, a system liaising a customer and a selected merchant for automatically calculating and managing customer earned equity, comprising:
means to enable and complete customer registration if the customer is not registered with said system;
means to provide access to the customer after verification, if the customer is registered with said system;
merchant interface means which includes information enabling the customer to select a merchant and a product/service which the customer wishes to purchase, said merchant interface means including:
(i) means to verify customer's credit;
(ii) means to receive, verify and record the customer's registration/access information;
(iii) means responsive to customer's transaction fulfillment, for generating signals indicating completion of a purchase transaction;
means in the system for storing a selected merchant's equity credit calculation information and equity conversion and redemption rules; and
a programmed processor, which responsive to said signals and said equity conversion and redemption rules, generates calculated equity credit information which indicates equity stock earned by the customer, for said purchase made from a selected merchant.

14. The system as in claim 13, which includes a database containing customer information including information pertaining to customer registration and all customer transactions.

15. The system as in claim 13, including a customer equity credit database which stores updated information of customer equity credits earned by customers, and an identity of corresponding merchants.

16. The system as in claim 13, wherein said selected merchant's equity credit calculation information and equity conversion and redemption rules include any limitations and conditions which the selected merchant wishes to impose on the customer's earned credit equity.

17. The system as in claim 13 including a merchants' services and products database which keeps an updated version of information pertaining to all merchants who have wished to be affiliated with the system, said updated version of information including the merchants' products and services and being accessible to customers to view, and select from.

18. The system as in claim 17 including an equity credit database and a customer equity credit redemption process module which includes an equity credit redemption rules database storing rules from all affiliated merchants, said module interacting with said equity credit database to produce a document, voucher or other electronic record indicating a value of customer earned equity, said module having means to transmit information from said document voucher or other electronic record to a securities broker/dealer if a customer has so elected.

19. In electronic commerce where customers on line can select a merchant and an offered product/service/promotional deal for purchase, and wherein a selected merchant wishes to participate in a plan to reward a customer with earned equity stock from the selected merchant's equity holdings, said earned equity stock being commensurate with customer's purchase, a system liaising a plurality of customers as potential purchasers with a plurality of merchants who wish to participate in and be part of the system, for automatically calculating and managing customer earned equity, said system comprising:
means to enable said plurality of customers and said plurality of merchants to participate in the system;
means offering access to any of said plurality of customers to participating merchants' information including available products, services, promotional deals and their corresponding prices;
means storing merchants' equity credit calculation rules and equity redemption rules; and
a processor including a software program which, based on said credit calculation rules and equity redemption rules as well as a single customer's completed purchase information, automatically generates calculated earned credit equity information for said single customer.

20. A system as in claim 19 wherein said means offering access includes means prompting a customer to select a merchant and a product/service/promotional deal.

21. A system as in claim 20, including means for receiving verification and recording of a selected merchant's data concerning customer registration and transaction fulfillment.

22. A system as in claim 19 which includes a customer equity credit database which stores for each customer an identification, details of purchases made and corresponding customer earned equity credit.

23. In electronic commerce where customers on line can select a merchant and an offered product/service/promotional deal for purchase, and wherein a selected merchant wishes to participate in a plan to reward a customer with earned equity credit from the selected merchant's stock holdings, said earned equity stock being commensurate with customer's purchase, a method for liaising a plurality of customers as potential purchasers with a plurality of merchants who wish to participate in and be part of the system, for automatically calculating and managing customer earned equity, said method comprising the steps of:
enabling said plurality of customers and said plurality of merchants to participate in the system;
offering access to any of said plurality of customers to participating merchants' information including available products, services, promotional deals and their corresponding prices;
storing merchants' equity credit calculation rules and equity redemption rules; and
using a processor including a software program for automatically generating calculated earned credit equity information for a single customer, based on said credit calculation rules and equity redemption rules as well as said single customer's completed purchase information.

24. A method as in claim 23 wherein said step of offering access includes selectively prompting a customer to select a merchant and a product/service/promotional deal.

25. A method as in claim 24 including receiving verification and recording of a selected merchant's data concerning customer registration and transaction fulfillment.

26. A method as in claim 23 which includes the step of storing in a customer equity credit database information for each customer including an identification, details of purchases made and corresponding customer earned equity credit.

27. A method as in claim 23 including the step of automatically initiating preparation of customer earned equity documents.

28. A method as in claim 23 including the step of sending said calculated earned equity information to a securities broker after concurrence with said single customer.

29. A method as in claim 23 including the step of maintaining an updated merchants' products/services database accessible to said plurality of customers.

30. A method as in claim 23 including the step of interactively offering said single customer options regarding how the earned equity credit can be redeemed.

31. A system for automatically calculating a customer earned reward, based on purchases made by a customer with a merchant/provider, comprising:
a new customer registration unit for registering a new customer into the system;
a customer access unit for identifying an already registered customer and for providing access for the registered customer into the system;
a merchants/services/products database which stores information pertaining to different merchants, their products, services and prices therefor;
a merchant interface which receives, verifies, and records a customer's access/registration information and purchase transaction fulfillment information, including means for generating signals indicating completion of a purchase transaction and payment therefor;
a customer registration and transactions database connected to receive customer registration and transactions information;
a rules database and calculation unit which holds merchant equity credit calculation rules in storage and including means based thereon for calculating the customer earned reward in the form of equity stock in a merchant's/provider's ownership equity interest commensurate with a customer's purchase;
an equity credit database which stores customer's earned equity information; and
a unit which is responsive to equity credit redemption rules stored in the system and responsive to customer's earned equity information to selectively generate a document, a voucher, or other redeemable grant in electronic form, showing a customer's earned equity interest from a purchase completed by a customer.
